(19) United States
(12) Patent Application Publication
(10) Pub. No.: US 2010/0316246 A1
(43) Pub. Date: Dec. 16, 2010

(54) SPEAKER DEVICE FOR PORTABLE TERMINAL

(75) Inventors: Young-Jun CHO, Gyeonggi-do (KR); Hui-Won CHO, Gyeonggi-do (KR); Austin KIM, Gyeonggi-do (KR); Yong-Jin KIM, Seoul (KR); Jae-Ho LEE, Gyeonggi-do (KR); Byung-Man LIM, Seoul (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/794,838

(22) Filed: Jun. 7, 2010

(30) Foreign Application Priority Data
Jun. 10, 2009 (KR) 10-2009-0051236

(51) Int. Cl. H04R 1/02

(52) U.S. Cl. 381/386

(57) ABSTRACT

A speaker device for a portable terminal is provided. The device includes a case frame forming an exterior of the portable terminal, a speaker installation space provided at an inner surface of the case frame to install a speaker therein, a barrier wall formed to provide a resonance space near the speaker installation space, and a cover installed to seal the resonance space.

### CLAIM OF PRIORITY

This application claims the benefit of priority, under 35 U.S.C. §119(a) of that Korean Patent Application filed in the Korean Intellectual Property Office on Jun. 10, 2009 and assigned Serial No. 10-2009-0051236, the entire disclosure of which is hereby incorporated by reference in its entirety.

### BACKGROUND OF THE INVENTION

1. Field of the Invention

The present invention relates to a speaker device applicable in a portable terminal. More particularly, the present invention relates to a speaker device for a portable terminal having a resonance structure to emit an improved speaker sound using the existing speaker.

2. Description of the Related Art

In recent years, with a rapid popularity of portable terminals, manufacturers are now in race to meet users' demands to provide more features and functions to the portable terminals while making the portable terminals to be lighter, thinner, and simpler. Particularly, efforts are concentrated to enable essential constituent elements (e.g., a display device, a speaker device, a microphone device, etc.) of the portable terminal to function better and at its full capacity.

Among the constituent elements, specifically, the speaker device is installed within the portable terminal but separately from a receiver device. The speaker device is typically installed near the microphone device of the portable terminal for communication or for purpose of listening to voice or sound in music listening through an Mpeg Player 3 (MP3) player, airwaves viewing through a Digital Multimedia Broadcast (DMB) module, etc. To this end, at least two speaker devices may be installed to simulate a stereo function.

As portable terminals are in trend of gradually getting slimmer, a speaker device installed near a microphone device, a receiver device, a vibrator, etc. have been also miniaturized and their installation structures have been simplified as well. To realize this miniaturization and installation simplification, other devices are employed in the vicinity of the microphone device of the portable terminal, such as a vibrator, which is disposed to an inner space of a box type carrier. That is, after the carrier receives or accommodates the speaker, the vibrator, etc., the carrier itself is fixed within a case frame of the portable terminal. Also, an antenna radiator may be applied onto an upper surface of the carrier.

However, the above-type configuration results in a reduction of a resonance space in a portable terminal and has a problem in that a sound pressure emitted from the speaker device noticeably decreases which n turn generates a poor speaker sound.

### SUMMARY OF THE INVENTION

An exemplary aspect of the present invention is to substantially solve at least the above problems and/or disadvantages and to provide at least the advantages below. Accordingly, one aspect of the present invention is to provide a speaker device for a portable terminal to generate a higher quality sound using the existing speaker.

Another exemplary aspect of the present invention is to provide a speaker device for a portable terminal realized to exclude a carrier for accepting a speaker unit to generate a high quality sound through expansion of a resonance space.

A further exemplary aspect of the present invention is to provide a speaker device for a portable terminal realized to contribute to generating a high quality speaker sound, by excluding a carrier and providing a resonance space with only its own structure of a terminal case frame.

A yet another exemplary aspect of the present invention is to provide a speaker device for a portable terminal that exhibits an excellent radiation characteristic, by using a structure of an inner surface of a terminal case frame as a speaker resonance space and simultaneously preparing an antenna radiator installation space.

In accordance with an exemplary aspect of the present invention, a speaker device for a portable terminal is provided. The device includes a case frame forming an exterior of the portable terminal, a speaker installation space provided at an inner surface of the case frame to install a speaker therein, a barrier wall formed to provide a resonance space near the speaker installation space, and a cover installed to seal the resonance space.

### BRIEF DESCRIPTION OF DRAWINGS

The above features and advantages of the present invention will become more apparent from the following detailed description when taken in conjunction with the accompanying drawings in which:

FIG. 1 is a perspective diagram illustrating a portable terminal with a speaker device according to the present invention;

FIG. 2 is an exploded perspective diagram illustrating a speaker device according to the present invention; and

FIG. 3 is a perspective diagram illustrating an assembled state of a speaker device according to the present invention.

### DETAILED DESCRIPTION

The following description, with reference to the accompanying drawings, is provided to assist in a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person or ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Although a slide type portable terminal is illustrated and described in the present invention, this does not intend to limit the scope of the present invention. An exemplary embodiment of the present invention may be applicable to, for example, various electronic equipments having a speaker device and requiring a resonance space.

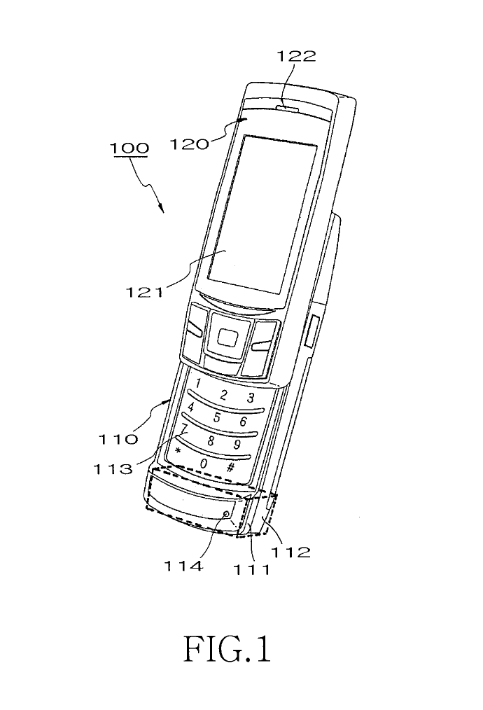

FIG. 1 is a perspective diagram illustrating a portable terminal 100 with a speaker device according to the present invention. FIG. 1 illustrates a slide type portable terminal, but it should be noted that teachings of the present invention may be applied to other type portable terminals.

As shown, the slide type portable terminal 100 includes a main body 110, and a slide body 120. A plurality of key buttons 113 are installed on a surface of the main body 110 that is exposed when the slide body 120 is opened, and a microphone 114 is installed at a lower side of the key buttons 113. A display device 121 is installed on the slide body 120, and an earpiece 122 is installed at an upper side of the display device 121.

According to the present invention, the speaker device is installed within a dotted line portion of FIG. 1. In more detail, the speaker device is constructed to emit a speaker sound toward the rear of the main body 110 that includes an upper case frame (i.e., a front case frame) 111 and a lower case frame (i.e., a rear case frame) 112. Thus, a resonance structure is formed in the rear case frame 112 rather than the front case frame 111.

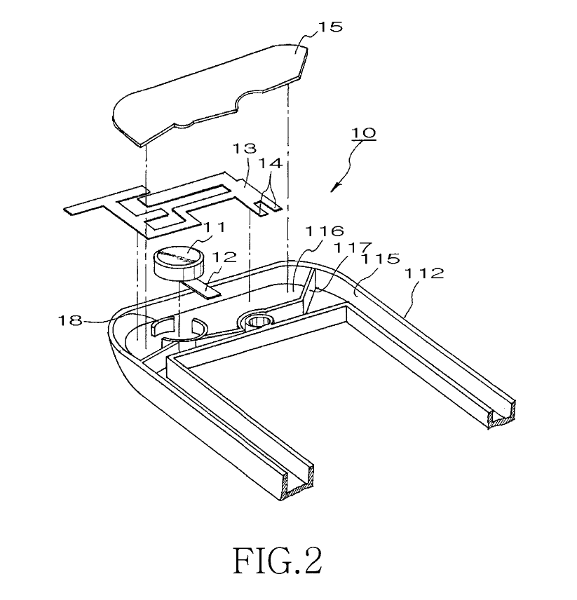

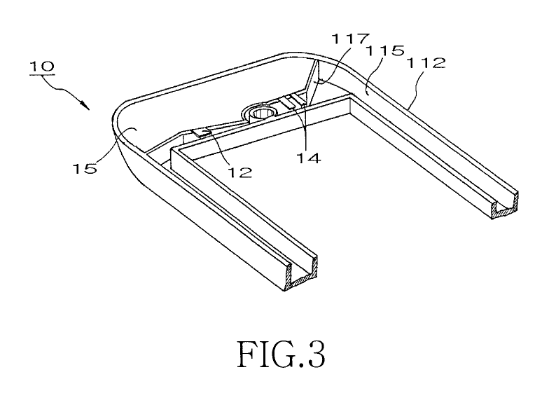

FIG. 2 is an exploded perspective diagram illustrating a speaker device according to the present invention. FIG. 3 is a perspective diagram illustrating an assembled state of the speaker device according to the present invention.

As illustrated in FIGS. 2 and 3, a speaker sound resonance space according to the present invention is provided in a microphone installation space portion of the rear case frame 112 of the main body 110. It is preferably that the speaker sound resonance space is provided in which the rear case frame 112 made of synthetic resin material is extruded.

The rear case frame 112 includes a bottom surface 116, and a side surface 115 extending as much as a predetermined height along an edge of the bottom surface 116 to provide the resonance space. A barrier wall 117 of a constant height is formed on the bottom surface 116 to connect up to both of the side surfaces 115 of the rear case frame 112. Hence, at a bottom part of the rear case frame 112, a constant space is provided by the barrier wall 117 and the side surface 115. By installing a speaker 11 in this space and covering the space with a cover 15, the completely airtight resonance space can be provided.

A busing 18 for fixing the speaker 11 is protrusion-formed in the resonance space. The bushing 18 can be formed in various shapes; however, can further include a sound emission path for making an emitted speaker sound resonate by way of the resonance space.

A recent trend is to apply a speaker module accepting carrier and an antenna radiator together. In accordance with this trend, an antenna radiator 13 and the resonance space can be arranged together in the present invention. That is, the antenna radiator 13 can be arranged in the resonance space. Preferably, the antenna radiator 13 can be a Planar Inverted F Antenna (PIFA). In this case, it is desirable to install or attach the antenna radiator 13 to a bottom part within the resonance space, i.e., an inner surface of the rear case frame 112.

The antenna radiator 13 may be a well-known Flexible Printed Circuit (FPC) pattern having a constant shape attached to the inner surface of the rear case frame 112 within the resonance space, or a metal plate of a constant pattern shape attached to the inner surface of the rear case frame 112 within the resonance space. Also, a conductive spray on the inner surface of the rear case frame 112 is coated within the resonance space according to a constant pattern.

If the antenna radiator 13 is applied to the inner surface of the rear case frame 112 within the resonance space, an excellent radiation characteristic can be realized because a PIFA can maintain the longest distance from a ground part of a main board of the portable terminal 100.

The speaker device having the above construction is assembled as follows. First, the speaker 11 is fixed to the speaker installing bushing 18 that is protrusion-formed within the resonance space inside the rear case frame 112. Also, the antenna radiator 13 is attached to the bottom surface 116 of the resonance space. In case that an FPC or metal plate is used as the antenna radiator 13, attachment will be able to be fulfilled in a bonding method, etc. After that, the cover 15 is installed to cover the resonance space. The cover 15 is used for sealing the resonance space. The cover 15 may be also fixed in the known method such as bonding, bolt coupling, ultrasonic fusion, etc. At this time, an electrical connector (e.g., an electric supply pad, a ground pad, etc.) of the antenna radiator 13 may be realized to protrude outside the cover 15 to facilitate electrical connection to the main board of the portable terminal 100. The speaker 11 may be also realized such that an electrical connection pad 12 protrudes outside the cover 15.

According to an exemplary embodiment of the present invention, a speaker device for a portable terminal has an effect that it can contribute to slimming of the portable terminal because promoting expansion of a resonance space with only its own structure of a case frame without a separate carrier, and can realize the greatest radiation performance compared to existing performance if an antenna radiator is installed within the resonance space.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A speaker device for a portable terminal, comprising:
a case frame defining an exterior of the portable terminal;
a speaker installation space provided at an inner surface of the case frame to accommodate a speaker therein;
a barrier wall formed to provide a resonance space around the speaker installation space; and
a cover installed to seal the resonance space.

2. The device of claim 1, wherein the barrier wall is integrally formed at the time of case frame extrusion.

3. The device of claim 2, wherein a speaker installing bushing is integrally protrusion-formed in the resonance space at the time of case frame extrusion.

4. The device of claim 1, wherein an antenna radiator is further installed or formed at the inner surface of the case frame within the resonance space.

5. The device of claim 4, wherein the antenna radiator is a Flexible Printed Circuit (FPC) comprising a radiation pattern.

6. The device of claim 4, wherein the antenna radiator is a metallic plate having a radiation pattern shape.

7. The device of claim 4, wherein the antenna radiator comprises a radiation pattern shape and is a conductive spray coated on the inner surface of the case frame.

8. The device of claim 4, wherein the antenna radiator is a Planar Inverted F Antenna (PIFA).

9. The device of claim 8, wherein the antenna radiator is applied to the inner surface of the case frame being at the longest distance from a ground part of a main board of the portable terminal.

10. The device of claim 4, wherein an electrical connector portion of the speaker and the antenna radiator protrude outside the cover to facilitate electrical connection with a main board of the portable terminal.

11. A portable terminal, comprising:
a case frame defining an exterior of the portable terminal;
a speaker installation space provided at an inner surface of the case frame to accommodate a speaker therein;
a barrier wall formed to provide a resonance space around the speaker installation space; and
a cover installed to seal the resonance space.

12. The portable terminal of claim 11, wherein the barrier wall is integrally formed at the time of case frame extrusion.

13. The portable terminal of claim 12, wherein a speaker installing bushing is integrally protrusion-formed in the resonance space at the time of case frame extrusion.

14. The portable terminal of claim 11, wherein an antenna radiator is further installed or formed at the inner surface of the case frame within the resonance space.

15. The portable terminal of claim 14, wherein the antenna radiator is a Flexible Printed Circuit (FPC) comprising a radiation pattern.

16. The portable terminal of claim 14, wherein the antenna radiator is a metallic plate having a radiation pattern shape.

17. The portable terminal of claim 14, wherein the antenna radiator comprises a radiation pattern shape and is a conductive spray coated on the inner surface of the case frame.

18. The portable terminal of claim 14, wherein the antenna radiator is a Planar Inverted F Antenna (PIFA).

19. The portable terminal of claim 18, wherein the antenna radiator is applied to the inner surface of the case frame being at the longest distance from a ground part of a main board of the portable terminal.

20. The portable terminal of claim 14, wherein an electrical connector portion of the speaker and the antenna radiator protrude outside the cover to facilitate electrical connection with a main board of the portable terminal.
